(19) United States
(12) Patent Application Publication
(10) Pub. No.: US 2016/0071491 A1
(43) Pub. Date: Mar. 10, 2016

(54) MULTITASKING AND SCREEN SHARING ON PORTABLE COMPUTING DEVICES

(71) Applicant: Jeremy BERRYMAN, Brossard (CA)

(72) Inventor: Jeremy Berryman, Brossard (CA)

(21) Appl. No.: 14/784,143

(22) PCT Filed: Apr. 10, 2014
(86) PCT No.: PCT/CA2014/000345

§ 371 Date: Oct. 13, 2015

Related U.S. Application Data
(60) Provisional application No. 61/910,104, filed on Nov. 28, 2013.
(60) Provisional application No. 61/810,443, filed on Apr. 10, 2013.

(51) Int. Cl. G09G 5/14; G06F 3/0484; G06F 3/041; G06F 3/0481

(52) U.S. Cl. CPC G09G 5/14; G06F 3/0481; G06F 3/0484; G06F 3/0418; G06F 2203/04803

(57) ABSTRACT

An application framework allows for running a primary media application and selecting and manipulating one or more other applications simultaneously on the screen without disrupting the primary media. The framework can even have the ability to send an SMS message without disrupting the primary media in play. This is a multitasking framework process with an unlimited potential of primary media and sharing screens.

### CROSS-REFERENCE TO RELATED APPLICATIONS

This application claims priority of U.S. provisional patent application 61/810,443 filed Apr. 10, 2013 and U.S. provisional patent application 61/910,104 filed Nov. 28, 2013, the specifications of the foregoing provisional patent applications is hereby incorporated by reference.

### BACKGROUND

(a) Field

The subject matter disclosed generally relates to screen sharing on portable computing devices.

(b) Related Prior Art

Portable computing devices have small displays, especially smartphones. By default, these devices allow for running multiple applications in the background, but only one application may be displayed on the screen at a given time.

With the trends for playing games, watching video and social interaction on smartphones at an all time high, users are bombarded with constant messages, emails, social media and more as they attempt to enjoy their media. The user then has the choice to either exit the media to interact in other smartphone activities and return back after to their media or remain in their current media with no access to other functions. None of the current top social media (Facebook, Twitter, Pinterest, eBay, Gmail, Google, Tumblr, YouTube, etc . . . ) offer a multi screen process within one application accessing all of the social media in an organized split window interface with a simultaneous primary media in play quickly interchanging shared screens between one another. There is much value gained for businesses and users with a technology of this manner.

There is therefore a high demand for a multitasking technology which allows the user to quickly toggle between full screen media and split screen multitasking so that the user can still watch their preferred media without interruption (e.g. a medical procedure video multitasking with medical professors via various social media pages).

However, several obstacles stand in the way of screen sharing between apps on smartphones. For example, no smartphone manufacturer allows the developer to access its operating system in order to edit previously made apps and merge them with one another within a developer's app.

Apple®'s IOS® in particular is very adamant on a developer's environment confined within the application itself. For instance IOS® does not allow for merging two applications, and does not allow for overlapping two applications or running them at the same time. It also does not allow the user to exit the app visually running and minimize the size into a mini screen over its operating system, and does not allow for playing with the content of the way other applications run.

Therefore, there remains a need for an app framework which allows for running a primary media application and selecting and manipulating one or more other applications simultaneously on the screen without disrupting the primary media. A framework which can even have the ability to send an SMS message without disrupting the primary media in play. This is a multitasking framework process with an unlimited potential of primary media and sharing screens.

### SUMMARY

The present application provides for such app framework.

In an aspect, there is provided a method for screen sharing on a portable computing device having a display device, the method comprising:
running a first application (app) comprising a primary media element on a display area;
receiving a user input touching/pressing/clicking over a predefined region of the display area;
in response to the user input, displaying a banner comprising a list of content elements pertaining to different apps (EOA), each EOA representing only a portion of available functions in a given app;
receiving a user input selecting a given EOA of a second app different than the first app;
in response to the user selection of the given EOA:
   dividing the display area into two different regions including a first region and a second region;
   running only the primary media element of the first app as a primary EOA in the first region; and
   running the given EOA of the second app as a secondary EOA in the second region;
   thereby running content elements of different apps simultaneously on the display device of portable computing device.

According to another aspect, the steps of receiving to running the selected EOA exclude any pausing and/or interruption of the primary media element of the first app.

According to another aspect, the method further comprises extracting the EOAs from existing apps using an API (application program interface) feed.

According to another aspect, the method further comprises receiving a user input touching/pressing/clicking over another predefined region of the display area, and, in response, displaying a search box for searching primary media of the first app in the second region without interrupting/pausing a media element content currently playing in the first region.

According to another aspect, the method further comprises receiving a user input swiping the first region in a given direction, and, in response, displaying the primary media of a second app different than the first app.

According to another aspect, the method further comprises receiving a user input swiping the first region in a given direction, and, in response, displaying a menu bar in the second region without interrupting/pausing a media content currently playing in the first region.

According to another aspect, the method further comprises receiving a user input swiping the banner in a given direction, and in response, displaying further EOAs.

According to another aspect, the method further comprises providing a location in the banner, said location when touched/pressed/clicked over causes an original order of EOAs to be restored in the banner.

According to another aspect, each EOA represents a single function of available functions in the given app.

According to another aspect, each EOA represents two or more functions of available functions in the given app.

According to another aspect, the method further comprises providing an invisible grid over the second region, the invisible grid comprising a plurality of different spaces, each space being associated with a given EOA, wherein upon receiving a user input over a given space running the EOA associated with the given space in the second region.

According to another aspect, the method further comprises providing a number of EOAs in groups and providing a virtual rolling wheel for displaying the EOAs associated with a given group in the banner.

According to another aspect, the method further comprises: color coding the groups.

According to another aspect, the portable computing device comprises an orientation sensing device, the method further comprising running the primary media on the entire display when sensing a change of orientation of the portable computing device.

According to another aspect, the change of orientation comprises a change from a portrait mode to a landscape mode.

According to another aspect, there is provided a computing device for implementing the foregoing methods.

According to another aspect, there is provided a user interface implemented on a computing device having a display, the interface comprising:
a display area for running a first application comprising a primary media; wherein upon detecting a user input over a selected region of the display area the interface displays a banner comprising a list of content elements pertaining to different apps (EOA), each EOA representing only a portion of available functions in a given app; wherein upon receiving a user input selecting a given EOA of a different app the interface divides the display area into two regions:
   a first region for running only the primary media of the first app as a primary EOA, and
   a second region for running the given EOA of the different app.

According to another aspect, the interface displays the banner and runs the secondary EOA without pausing/interrupting the primary media.

According to another aspect, the interface is adapted to provide a number of EOAs in groups and provide a virtual rolling wheel for displaying the EOAs associated with a given group in the banner.

According to another aspect, the interface is adapted to extract the EOAs from existing apps using API.

The embodiments describe an interface on a portable smart device e.g. iPhone or the like (iPad, iPod, tablets, computers, laptops, smart TVs), which allows for dividing the display into two regions or more. One region for running a primary media element of a first app e.g. a Youtube® video, and another region for running a secondary element from a second app which may be different than the first app and without interrupting the primary media during activation or search of the secondary element.

In the present document, the following terms are used interchangeably:
1. Portable device, portable computing device, device, smart phone, and phone.
2. Display and screen are used interchangeably to mean the display of the portable device.
3. Application and app.

In some instances, the display may be touch sensitive whereby the user may interface with the portable device by touching/taping on the display over selected areas/links.

### DEFINITIONS

In the present embodiment, the following terms are defined as follows:
Primary Media: A video, streaming video, live cam, video game or video chat, or any video based media.
API Feed: A developers code used to allow content from an outside source; such as, a server, a website or application to be accessed and shown within their website or application (i.e. video feed, user comments, Nexmo® SMS and voice messaging, OpenTok® live face to face video, weather temperatures in various countries etc.)
Multi sharing screens: Miniature windows within a smart device which are interchangeable with each other.
Launch bar (aka banner or taskbar): A bar with linked icons accessing specific apps
EOA (element of app): content element of a given App. EOAs represent only a portion of the functionalities provided in a given app (one or few). Examples of EOAs include Youtube® videos, Youtube® search, Youtube®, Nexmo® (SMS and voice messaging), comments etc.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1a to 1i illustrate different examples of an interface in accordance with the present embodiments;

FIGS. 2a, 2b, 2c, 2d and 2e illustrate an example for providing EOAs in groups, in accordance with an embodiment;

FIGS. 3a to 3c illustrate screenshots of two applications sharing the same screen of a portable device in accordance with an embodiment;

FIG. 4 illustrates an example of how the position of the applications may be changed within the screen;

FIGS. 5a and 5b illustrate an example of how one application may expand on the expense of another application, in one embodiment;

FIG. 6 illustrates an example of how a first application may be split in two portions to provide a second application between the two portions;

FIGS. 7a and 7b illustrate an example of how an application may be paused by changing the orientation of the phone;

FIGS. 8a and 8b illustrate an example of how the embodiments may be applied in the domain of sale;

FIGS. 8c and 8d illustrate an example of how the embodiments may be applied in the domain of education;

FIGS. 9a to 9c illustrate an example of how the embodiments may be applied in the domain of gaming;

FIGS. 10a and 10b illustrate an example of how the embodiments may be applied for synchronous viewing of videos from remote locations;

FIGS. 11a to 11c illustrate an example of how the embodiments may be applied for making emergency calls;

FIG. 12 is a flowchart of a method for screen sharing on a portable computing device having a small display device, in accordance with an embodiment; and

FIG. 13 illustrates an exemplary diagram of a suitable computing operating environment in which embodiments of the invention may be practiced.

It will be noted that throughout the appended drawings, like features are identified by like reference numerals.

### DETAILED DESCRIPTION

In an embodiment, a framework is provided which may run on any smartphone software platform e.g. IOS®, Android® etc., and which allows users to watch a primary media while being able to select and run one or more other programs on the screen simultaneously and without interrupting the primary media being watched. In an embodiment, the frameworks allows for extracting and selecting content elements from different applications using API and web browsers and running these elements simultaneously on the display (aka screen) without having to run the entire applications.

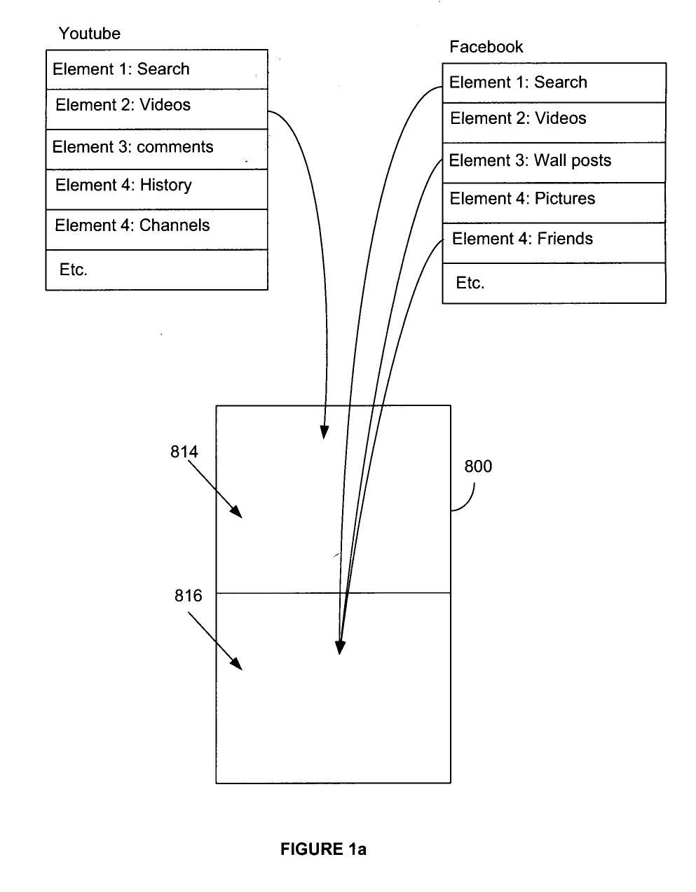

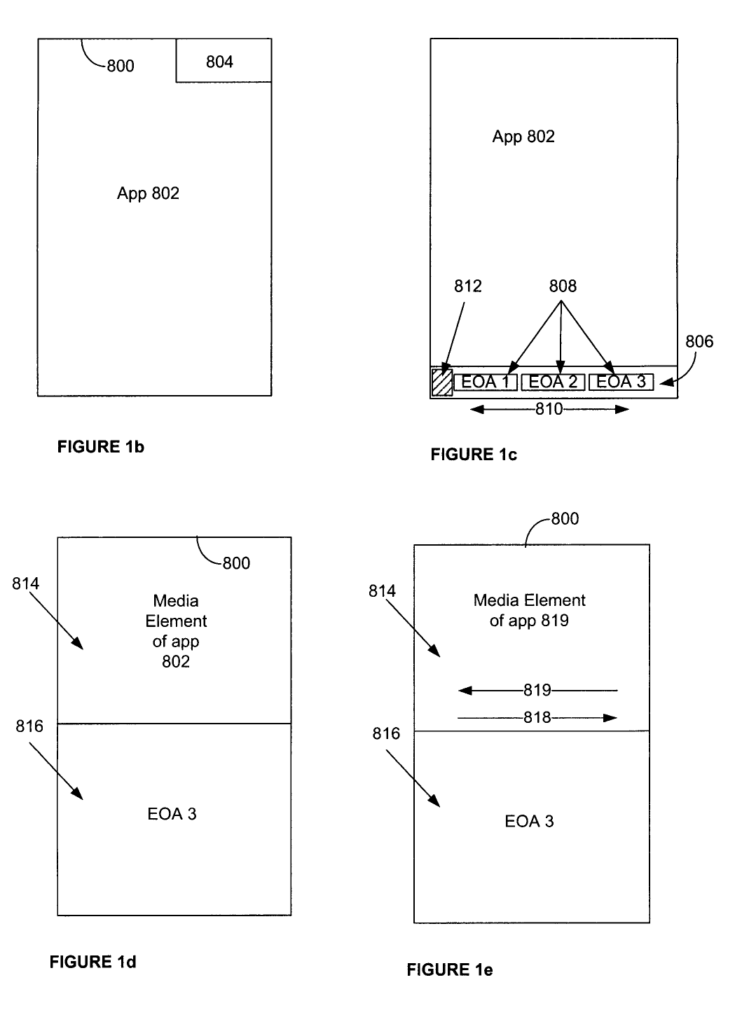

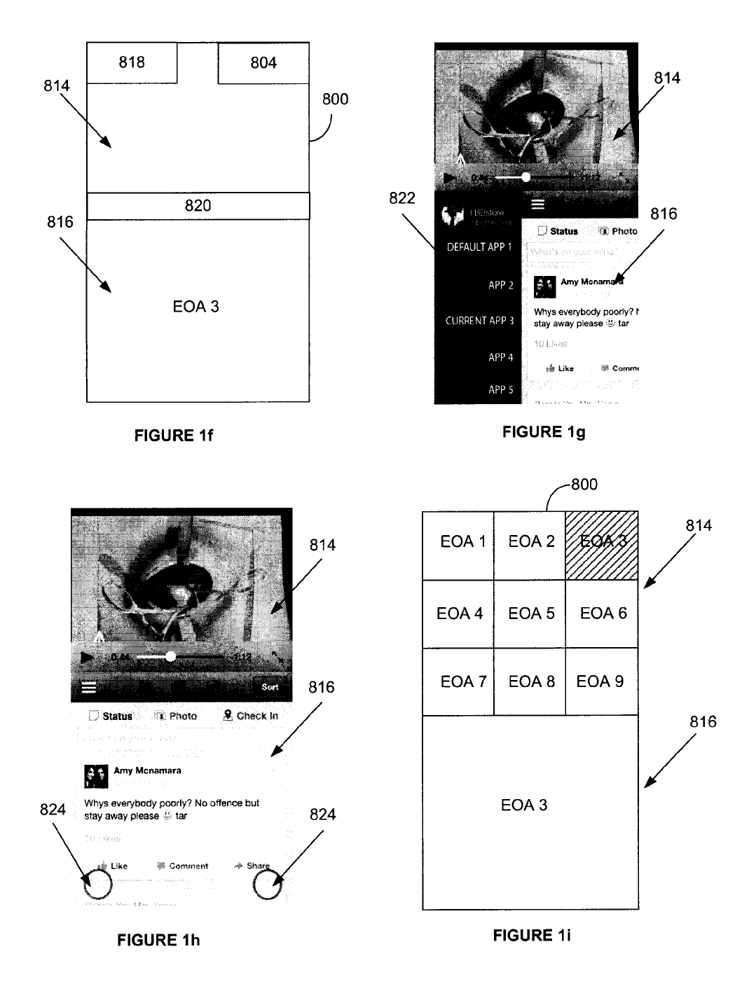

For example, the Facebook® app may include several elements such as video, pictures, comments, search, wall posts, newsfeed, timeline, etc. At the same time the Youtube® app includes several elements such as videos, comments, search, history, playlists etc. The embodiments describe an interface which combines primary media elements of one application with one or more secondary elements (media and non-media) from other applications, whereby the user may choose to run a primary media element on a portion of the display e.g. a Youtube® video, and select to run a secondary element (or more) of another application (or more) e.g. Facebook® wall, or Facebook® newsfeed, Google® search etc. on the other portion(s) of the display as exemplified in FIG. 1a, thereby allowing the user to select and run EOAs from different apps within the present interface without running the entire apps and without changing the way these apps work, thereby avoiding the IOS and Android platform limitations.

In an embodiment, searching for, selecting and running the secondary element is done without interrupting (i.e. pausing) the first media.

An example is provided below with reference to FIG. 1b.

As shown in FIG. 1b, an interface 800 is provided on a mobile device such as an iPhone® or the like, in accordance with an embodiment. The interface 800 may be used for running a first app 802 e.g. an app including a primary element like Youtube®. When the screen sharing mode is not activated, the interface 800 may run the first app 802 in its standard manner (as the original app usually runs) and by making available all the functionalities that the app 802 provides. For example, if the app 802 is the Youtube® app, the interface 800 may run a video on a portion of the display and provide the users' comments on the video or suggestions below the video like in a standard Youtube® app. If the user decides to activate the screen sharing mode and run another element e.g. check their Facebook® newsfeed, at the same time of watching the Youtube® video, the user may choose to activate/display a banner including a list of available secondary elements and select the secondary element(s) that they wish to run in a screen sharing mode.

For example, the user may press over/touch the display anywhere or at a given location e.g. region 804 as shown in FIG. 1b to display the banner 806 as shown in FIG. 1c. The banner 806 (aka taskbar 806) includes a plurality of elements of apps (EOA) 808 which may be run as secondary elements in the screen sharing mode at the same time as the primary media is running. The user may navigate/explore all the EOAs 808 by sliding the banner 806 to the left or right as indicated by arrow 810. The banner 806 may include a region 812 which when pressed on by the user brings back the original order of apps e.g. app1 followed by app 2 etc. In an embodiment the user may customize the order of the EOAs for a quick access to the EOA that are most used. In a further embodiment, the interface may arrange the order of the EOAs based on the frequency of use. The selection of a banner EOA may also be set to switch both the current primary media screen 814 and EOA 816 simultaneously or separate to a new EOA and primary media.

In an embodiment, upon receiving a user selection of a given EOA e.g. EOA 3 the interface may change its operation to run only the media element of the first app 802 (e.g. only the video of the Youtube® app) in one region 814 of the interface 800 and the selected EOA 3 in another second region 816 of the interface as exemplified in FIG. 1d. In another embodiment, upon receiving a user selection of a given EOA e.g. EOA 3 the interlace may be used to maximize region 816 over the primary media in play to fit most of most of 800 still exposing the top EOA region (EOA 1, EOA 2 and EOA 3) as exemplified in FIG. 1d. This allows access to the top EOA selections to access the banner for yet another EOA selection to reduce the maximized EOA 3 back to region 816, all without disrupting the primary media audio in play (in a case where the visual of the primary media is less important than the audio).

### Changing Primary Media

In an embodiment, the user may select another primary media to run in the region 814 by swiping the region 814 in one direction as exemplified by arrow 819. Whereby, the media element of another app 819 e.g. Vimeo, Quicktime, Facebook videos etc. is run as a primary media element in the first region 814 as indicated in FIG. 1e. The user may also open the menu bar 822 by swiping the region 814 in the opposite direction as exemplified by arrow 818. An example is shown in FIG. 1g. In an embodiment, the user may select another shared screen to run in the region 816 by swiping the region 816 in one direction as exemplified by arrow 819. The user may also open the menu bar 822 by swiping the region 816 in the opposite direction as exemplified by arrow 818. An example is shown in FIG. 1g.

### Search Primary Media

In a further embodiment, the interlace 800 may be configured so that upon detecting a user input pressing over another region 818, the interface may display a search box 820 which allows the user to search for more media from the app for which the media element is running in the primary region 814. For example, if the user is watching a Youtube® video in the region 814 and the user touches the region 818 a search box 820 may be displayed which allows the user to search for more videos from Youtube®. An example is shown in FIG. 1f.

It should be noted that the regions 818 and 804 are shown in the examples of FIGS. 1b and 1f for illustration and clarity purposes but, in reality they do not have to appear on the interface 800.

### Changing Secondary EOA

In another embodiment, the interface may display transparent browser arrows 824 in the second region 816 as shown in FIG. 1h. These arrows allow the user to transition to next and previous web browser pages and browser apps within the sharing screens without the need for a taskbar taking away from screen spacing. In an embodiment, the transparent arrows are fixed in place on the bottom corner of browsing multi sharing screens. In one embodiment the fixed arrows may be repositioned higher and/or more spaced out within the 816 region. In yet another embodiment an added icon which may be transparent may also be added within the 816 region; such as, maximize/minimize icon (to maximize the 816 region to the 800 region and then back again to the 816 region without disruption of the primary media's audio in play), a volume button, etc.

### Grid

In a further embodiment, an invisible grid defining a plurality of spaces may be provided in the interlace over the primary media region 814 for selecting/changing the secondary EOAs in the second region 816. Each space may be linked to a different EOA whereby by pressing over a given region of the grid the associated EOA e.g. EOA 3 may run in the secondary region 816, as exemplified in FIG. 1i and without interrupting the primary media running in the primary region 814.

It should also be noted that the grid and associated EOAs are invisible. FIG. 1i illustrates the grid and associated apps for illustrations purposes only. In another embodiment a top banner above the primary media in play may be provided covering a portion of EOA 1, EOA 2 and EOA 3 to assist in guiding users to the EOA selections.

### EOA Grouping

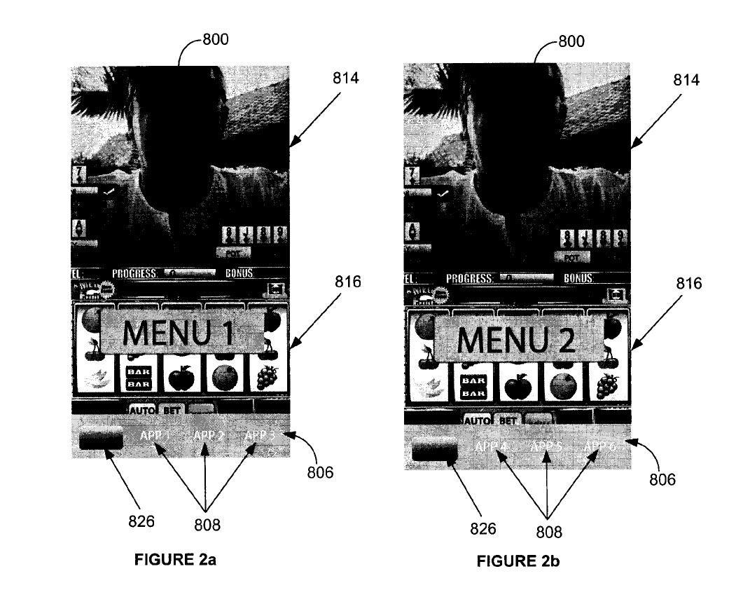

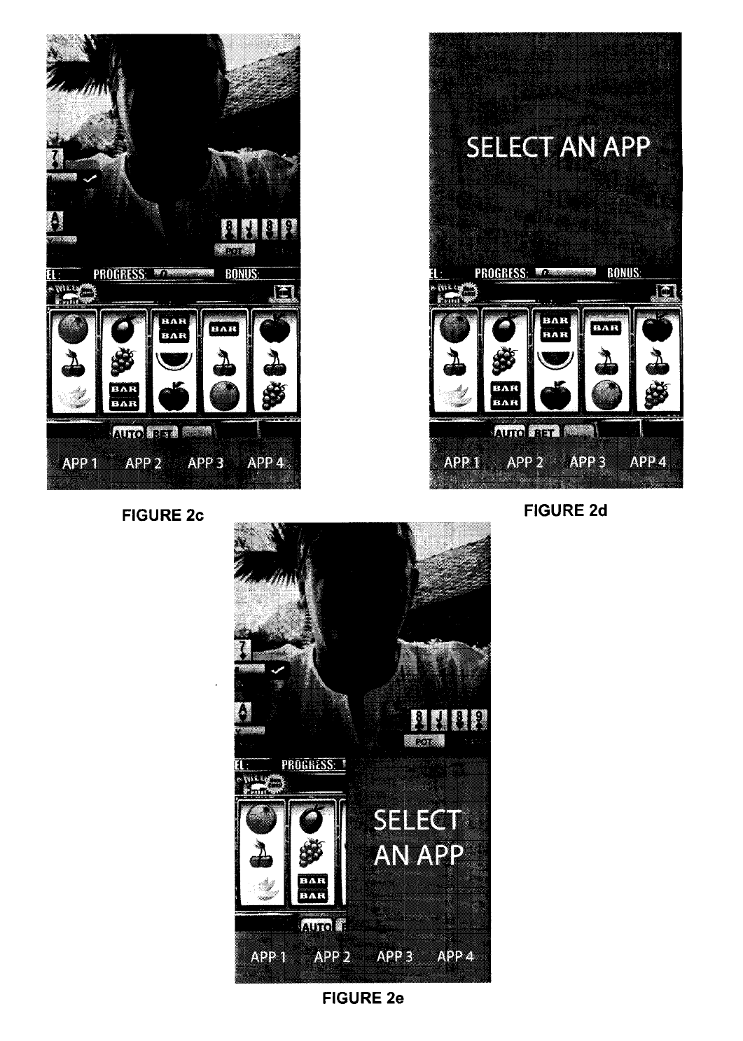

In an embodiment, the interface may provide the EOAs 808 in the banner 806 (shown in FIG. 1c) in the form of groups, whereby the user may personalize the interface to their choice by providing related EOAs in the same group. For example, the user may group together EOAs related to social media, music, news, friends, chat etc. In an embodiment, the user may switch between a group and another by rolling a virtual wheel on the interface as exemplified in FIGS. 2a and 2b. As shown in FIG. 2a the banner 806 may include a virtual rolling wheel 826 which by rolling up or down allows for changing the EOA groups. A visual indication 828 may also be displayed in the secondary region indicating the group name as indicated in FIGS. 2a and 2b.

In other embodiments (shown in FIGS. 2c, 2d and 2e), the user may personalize the size and location of the applications on the display to fit two or more simultaneously running applications on the display. In a further embodiment the user may personalize the location of the applications further by splitting a given application in two (or more) portions and inserting another application between these portions. These new portions will be best displayed on larger devices like tablets and larger Smartphone devices. In one embodiment the user may layer an application to run over the primary media in play as the process indicated in FIGS. 2c and 2d, allowing 2 applications plus the primary media's audio to run simultaneously.

The portable device may include an accelerometer (or compass, or the like) for sensing when the orientation of the portable device is changed; e.g., when the portable device is rotated between a portrait mode and a landscape mode (or vice versa). In a further embodiment, the portable device may be configured to pause an application; e.g., video or game, when the orientation of the portable device is changed and to un-pause when the original orientation is resumed. In another embodiment, when the device senses a change in orientation from portrait mode to landscape mode, the interface may allocate the entire display area to the primary media. The interface may resume the screen sharing when the device is returned to the portrait orientation.

Screenshots and Other embodiments

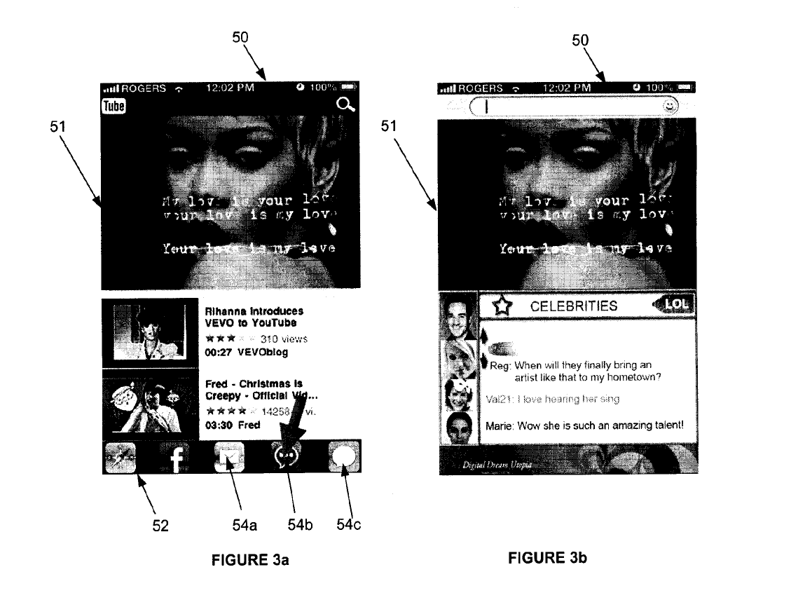

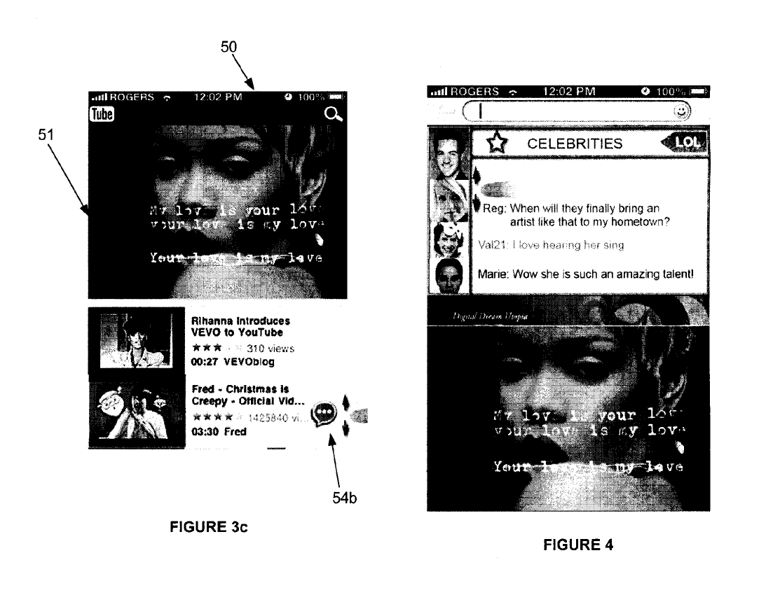

FIGS. 3a to 11c illustrate different examples and screenshots of the present and other embodiments.

FIGS. 3a and 3b illustrate an example of two applications sharing the same screen of a portable device in accordance with an embodiment.

Assuming that the user is running a video application 51 (e.g., Youtube®) on the screen in portrait mode. By tapping/touching the screen 50, a banner 52 may appear which includes a plurality of applications 54 the user may choose one or more of the applications 54 to run simultaneously on the screen 50. Assuming that the user chose the chatting application 54b, the chatting application 54b may run and share the screen with the video application 51 on the same screen 50, as illustrated in FIG. 3b.

In a non-limiting example of implementation, activation of the screen sharing mode may be done by dragging the second application 54b toward the screen and/or over the already running application 51, as exemplified in FIG. 3c. Other methods may also be used.

The user may adjust the size of each application on the screen to increase the size of one and to reduce the size of the other. In an embodiment, when the user adjusts the size of one application, the size of the other application may adjust automatically based on the first adjustment. For example, if two applications share the screen equally (50%-50%), and the user decides to increase to size of one of them to become 60%, the size of the other application may automatically shrink from 50% to 40% to avoid the overlap.

The following two methods are examples of screen sharing are proposed. In the first method, the resolution of one application may change to increase/decrease depending on the nature of the size change, whereby the content of the application will be shown in its entirety. In the second method, a portion of the content may be hidden without changing the resolution.

In another embodiment, the user may select the position of each application on the screen. FIG. 4 illustrates an example of how the position of the applications may be changed within the screen. For example, if the user wants to see the video at the lower half of the screen, the user may do so by dragging the lower half up, or the upper half down, or by putting a finger on each application and rotating the two fingers, etc. as exemplified in FIG. 4 which illustrates that the positions of the two applications 51 and 54b have been inverted with respect to FIG. 3b.

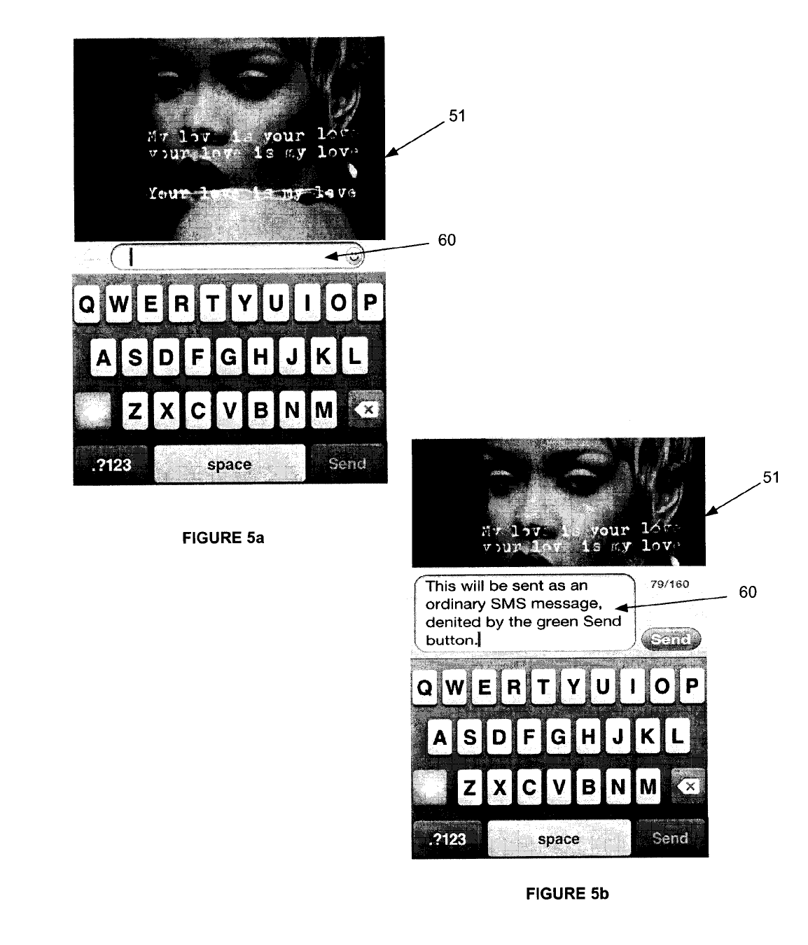

FIGS. 5a and 5b illustrate an example of how one application may expand at the expense of another application, in accordance with another embodiment. If the user decides to engage in a chatting session, the user may click/touch the text entry area to receive the screen displayed in FIG. 5a wherein the keyboard replaces the comments received from other users in the chat room. In the present embodiment, as the user types, the area 60 would expand upward over the video application 51 as exemplified in FIG. 5b.

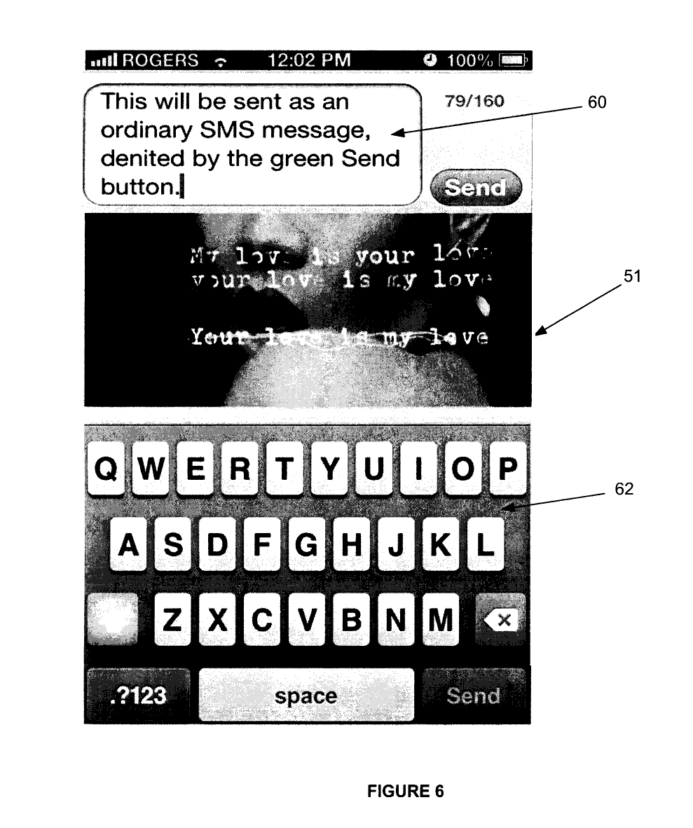

In another embodiment, the user may personalize the view further by splitting one application in two portions and providing the other application between the two portions. An example is provided in FIG. 6.

FIG. 6 illustrates an example of how a first application may be split in two portions to provide a second application between the two portions. As shown in FIG. 6, the text receiving portion associated with the keyboard is provided above at the top of the screen, the keyboard 62 is provided at the bottom of the screen and the video application 51 is provided between the two.

In another embodiment, it is also possible to configure the portable device so that the text does not expand on the expense of the video application (as in FIGS. 5a to 6). In the present embodiment, the user may only see one line of the text that they typed in order to maintain the size allocated to the other application.

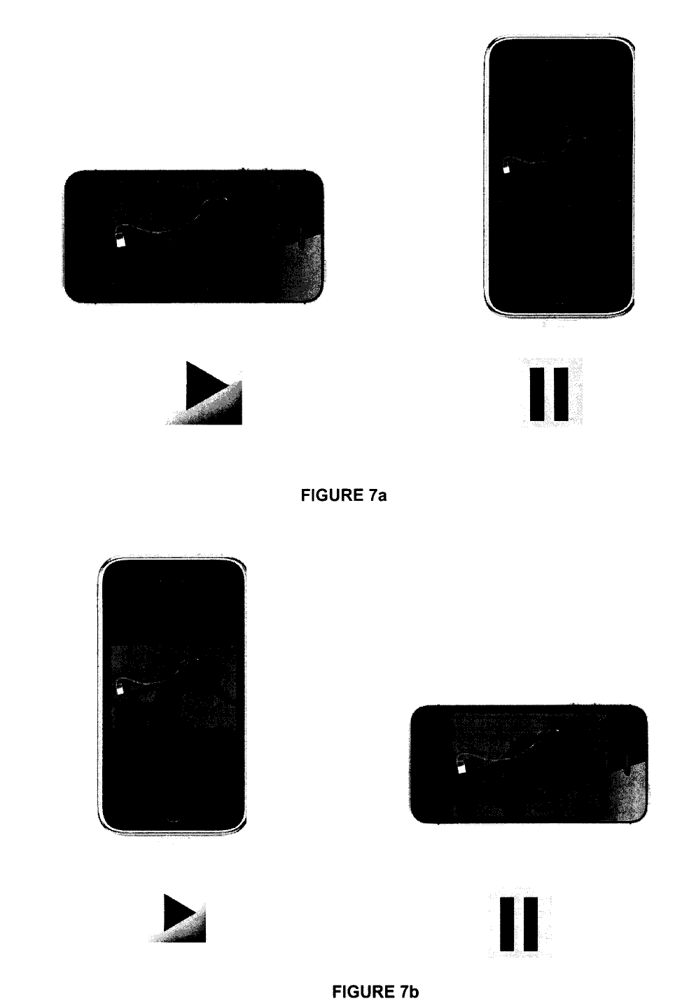

In a further embodiment, if the user is watching a video, a presentation, or playing a game while the portable device is in a given orientation, the application may pause by rotating the telephone or changing its orientation; e.g., portrait to landscape or vice versa. The application may un-pause when the phone is returned to its original orientation. An example is illustrated in FIGS. 7a and 7b.

FIGS. 7a and 7b illustrate an example of how an application may be paused by changing the orientation of the phone, in accordance with an embodiment.

This embodiment may be implemented with any of the embodiments above. For example, if the user is watching a video and they receive a text message, a visual indication may be displayed (by default) for a second or less to alert the user that a message has been received. The user may then rotate the phone, launch the messaging application to reply and return the phone to its original orientation to un-pause the video after writing the reply and sending it or while writing the reply (this way the user can watch the video after un-pausing it while typing the reply). Needless to say, the action of rotating the phone replaces the manual pausing/un-pausing of the application. In other words, the user does not have to manually pause/un-pause the application if they rotate the phone when practicing the present embodiment.

Accordingly, embodiments of the invention allow for multiple levels of screen personalization comprising: running multiple applications on the same screen, adjusting the size of each application within the screen, positioning the applications in any user selected location within the screen, splitting a first application and providing a second application between different portions of the first application, and pausing and un-pausing an application by changing the orientation of the phone.

The following description provides examples of areas in which the multitasking and screen sharing embodiments may be applied.

### 911 Calls

In one example, the application maybe used for conducting 911 calls and at the same time viewing the agent answering the call and recording or video streaming the caller or the crime screen. For instance, if the phone is in portrait mode, the user may view the police/security agent answering the call in one window and view what the camera of the phone is recording in a second window. For example, this allows the security agent to better guide the caller and/or witness the crime as it happens etc.

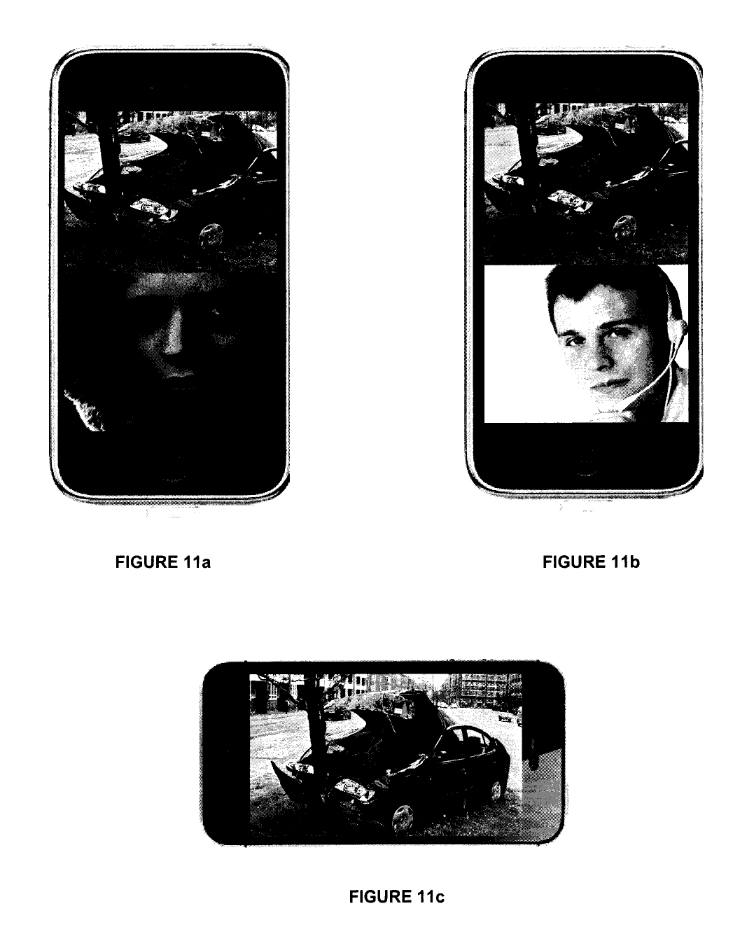

By rotating the phone in a landscape mode, one of the two windows will take the full screen as discussed above in connection to FIGS. 7a and 7b, and the other window will disappear, until the phone is returned to the portrait mode. The audio of both the agent and the caller continues as the caller puts the device in landscape mode. An example is shown in FIGS. 11a to 11c which illustrate an example of how the embodiments may be applied for making 911 calls. FIG. 11a shows the screen from the caller's view, while FIG. 11b shows the screen from the agent's view. FIGS. 11a shows the main view in landscape mode from either of the caller or the agent's side.

Dual Camera recoding

In another example, it is possible to activate the front and back cameras of a portable device and allocate a portion of the screen to each camera, whereby the user may record themselves and the scene they are looking at simultaneously, while streaming one or both screens to a second user over a wireless connection. For example, if the user is on the beach they may video tape themselves as well as the beach and stream one or both windows to a remote user. The user may also share the window of the beach they are recording with another user, as that user is viewed in a second window reacting to the recordings while taking part in the overall recording. In one embodiment, the recording is interchanged in various time allotments where every few seconds camera 1 switches to record on camera 2 or vice versa providing the user a visual seemingly as simultaneous when in actuality it is interchanging quickly.

Needless to say, both users must have the application installed on their respective devices. In an embodiment, user 1 may upload or record a video to send to user 2. User 2 receives and views the video as another recording occurs capturing the reaction of user 2. User 1 receives the final completed video, one window shows the original recorded video and the second window showing the reaction of user 2 synced with the video. In one embodiment, the receiving user 2 may be receiving the completed video on another device with a standard screen in screen view of user 1 within both screens.

### Sale

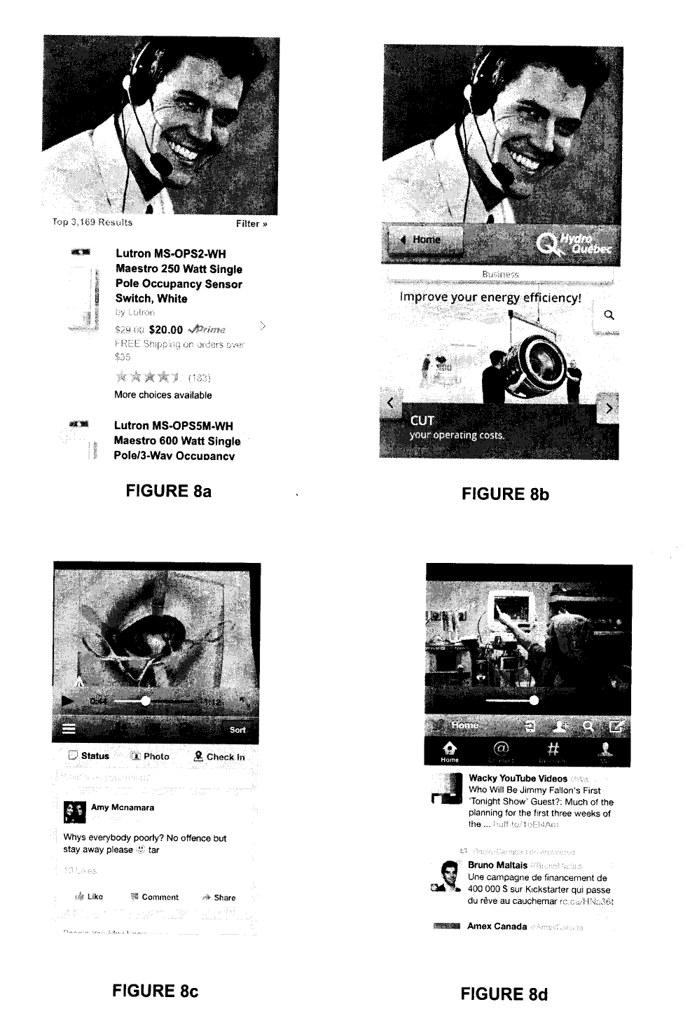

In a further example, the app may be used by sale personnel or the like, whereby the user receiving the call may browse a web site and/or view the salesperson at the same time. In an embodiment, the salesperson can guide the user receiving the call through the different products and promotions as exemplified in FIGS. 8a and 8b. In one embodiment, this video call may auto start via touch/press as a user is browsing the site and/or products and promotions.

### Education

In yet a further example, the application may be used for educational purposes whereby one portion of the screen may show a live feed of an experiment, surgery etc. while the second portion may display related notes, comments, questions or interactions, social media etc. as exemplified in FIGS. 8c and 8d. In one embodiment, the second portion may display a synced slideshow of visuals or products for sale timed to the primary media.

### Gaming

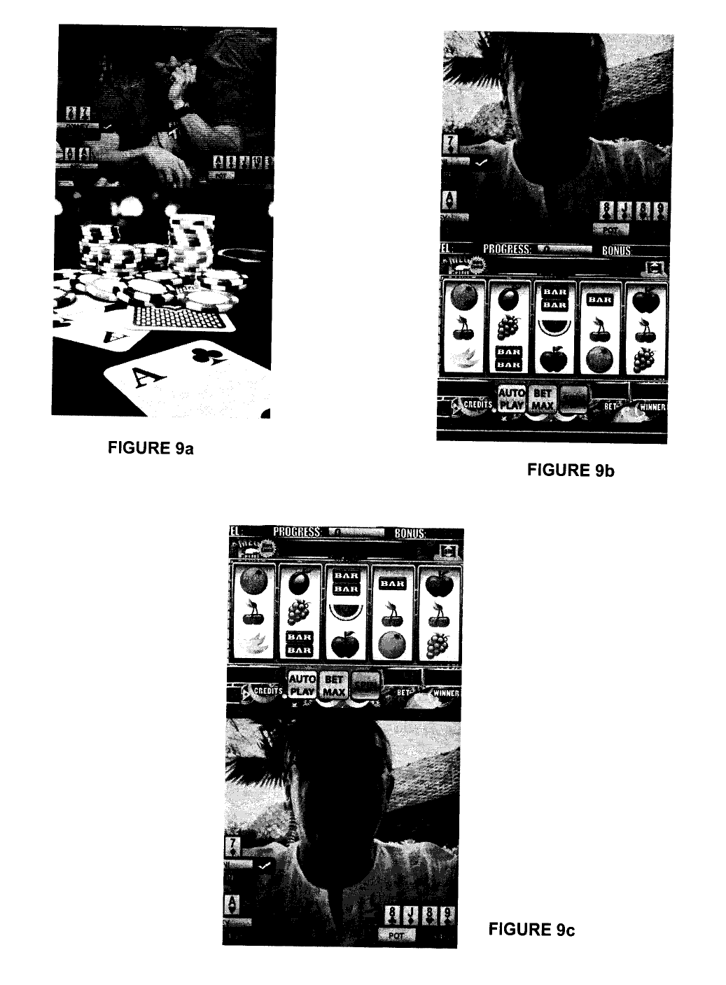

In yet a further example, the application may be used for enhancing the gaming experience, whereby the user may see the opponent or other gamers playing other games at the same time in one portion of the screen and the gaming table/device e.g. poker, slot machine in the second portion as exemplified in FIGS. 9a to 9c.

As shown in FIGS. 9b and 9c the user may switch the locations of the windows as desired. In one example, this may be done by placing a finger one each window and rotating the two fingers simultaneously. In other embodiment, the switching may occur by placing a finger on one window and pushing that window in an opposite direction e.g. pushing the upper window down, or the lower window up etc.

In an embodiment, if the game involves more than one player, the app may allow the user to choose one or more players to view when playing. The user may also have the option of blocking a certain player, blocking or activating the sound etc.

In order to make this feature possible without requiring too much data, the app may be configured to obtain and push a live feed of the corresponding player to a central server, which then, based on what each user selects may push the camera feed of a selected player/opponent or combine the views of more than one players and push this data to the user making the selection.

The player may have different modes to choose from. 1—portrait mode viewing the game only with no video cam, 2—portrait mode with the live cam of other players in one window and the game in play in the other, 3—Landscape mode viewing the game only, 4—Landscape mode with the live cam of other players in one window, and the game in play in the other. In one embodiment, there may be a master volume or separate volume levels for each video and/or game initiated by touching/pressing the screen as an EOA and/or an EOA banner selection.

If the player is playing in a split view mode where they see a player in live cam as they view the game they are playing, the user may switch live cam to other players by simply swiping on the live cam window (up, down, left or right).

Using the same principle, the interface may be adapted so that the screen sharing mode may be implemented when the device is in a portrait mode and when the device's orientation is changed to be in a landscape mode, the primary media would take over the entire display. The screen sharing mode may then be resumed when the device is brought back to portrait mode. It should be noted that this embodiment may be implemented without interrupting the playing of the primary media (the video).

### Synchronous Video Watching

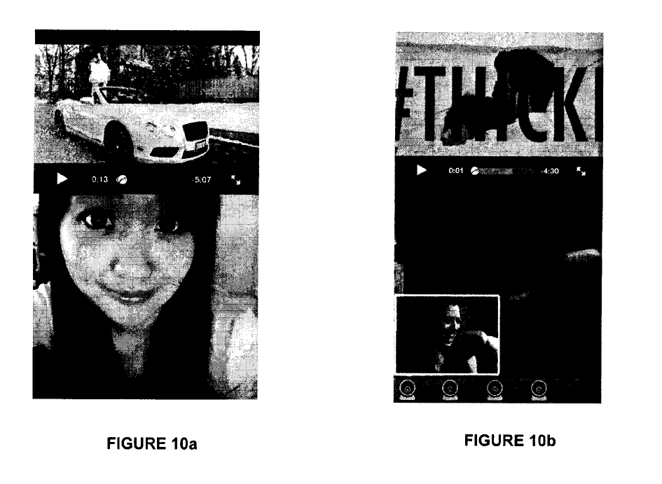

In yet a further example, the application may allow two or more remote users to watch a video synchronously while viewing each other's reactions to it. For example, the application may cause a video to be played synchronously on the devices of the remote users in one window while the second window streams a video from the other device. This allows two remote users to watch the same video/movie while viewing each other's reactions on the video as exemplified in FIGS. 10a and 10b. FIG. 10a shows the video that is being played in the upper window, and the second user in the lower window. FIG. 10b illustrates a further embodiment, in which the lower window shows the second user as well as the first user that is associated with the mobile device shown in the Figure (realize a smaller window within the second window). In one embodiment, all occurrences may be recorded and/or exported to social media for viewing later.

As discussed above, one of the windows may occupy the full screen by changing the orientation of the device from portrait mode to a landscape mode and vice versa.

Each user may choose to view the movie in full landscape mode from time to time or within the portrait mode to switch the live cam reaction window to other multi-tasking events such as checking e-mail, Facebook or other social media. In the cases the audio between both users may remain in the background.

### Solo Video Watching

While watching a video in portrait mode a second browser window is provided allowing the user to access social media and websites as they watch their videos. In an effort to maximize on space invisible buttons are added to the top of the screen playing the video. Tapping the top left or center of the screen opens up the launch bar in the second window with quick access links to popular sites and social media. Tapping the top right of the video screen opens up a search bar to search for videos.

### Flowcharts

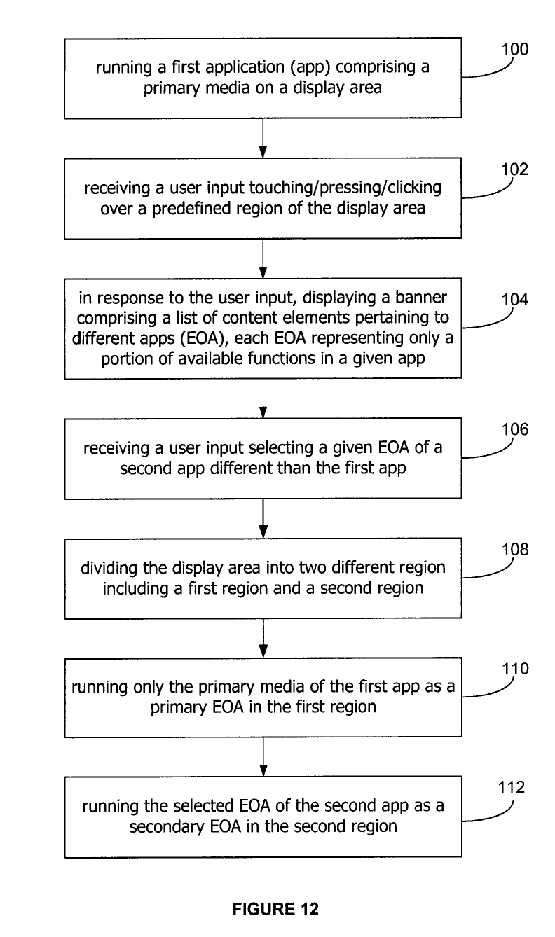

FIG. 12 is a flowchart of a method for screen sharing on a portable computing device having a small display device, in accordance with an embodiment. Step 100 comprises running a first application (app) comprising a primary media on a display area. Step 102 comprises receiving a user input touching/pressing/clicking over a predefined region of the display area. Step 104 comprises, in response to the user input, displaying a banner comprising a list of content elements pertaining to different apps (EOA), each EOA representing only a portion of available functions in a given app. Step 106 comprises receiving a user input selecting a given EOA of a second app different than the first app. Step 108 comprises, in response to the user selection of the given EOA: dividing the display area into two different region including a first region and a second region; running only the primary media of the first app as a primary EOA in the first region; and running the selected EOA of the second app as a secondary EOA in the second region.

### Hardware and Operating Environment

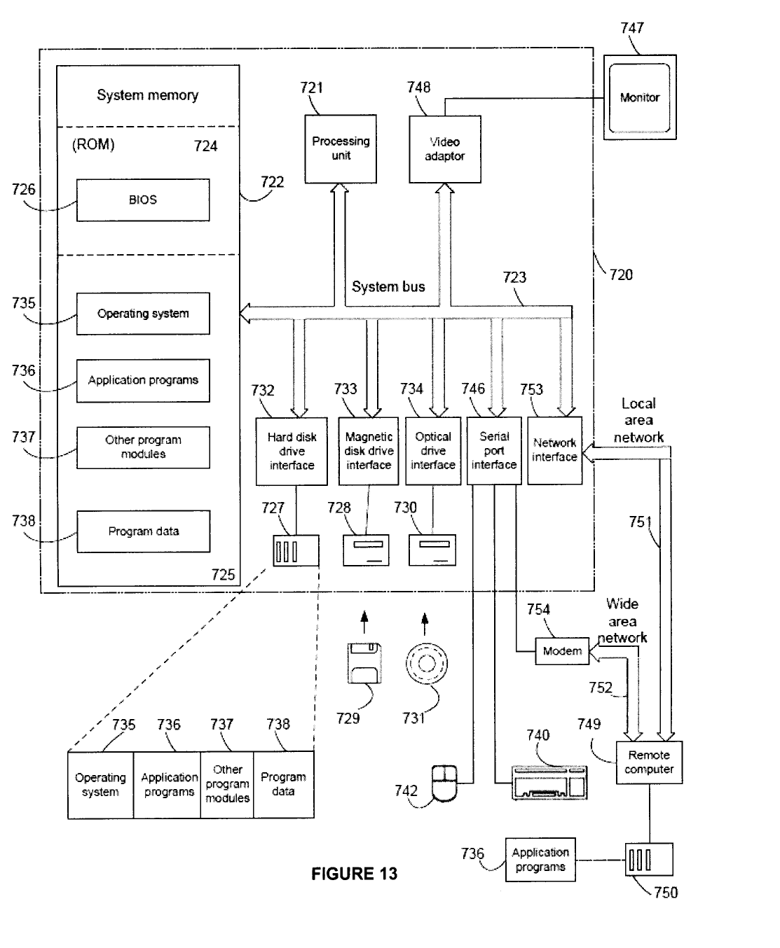

FIG. 13 illustrates an exemplary diagram of a suitable computing operating environment in which embodiments of the invention may be practiced. The following description is associated with FIG. 13 and is intended to provide a brief, general description of suitable computer hardware and a suitable computing environment in conjunction with which the embodiments may be implemented. Not all the components are required to practice the embodiments, and variations in the arrangement and type of the components may be made without departing from the spirit or scope of the embodiments.

Although not required, the embodiments are described in the general context of computer-executable instructions, such as program modules, being executed by a computer, such as a personal computer, a hand-held or palm-size computer, Smartphone, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the embodiments may be practiced with other computer system configurations, including hand-held devices, multiprocessor systems, microprocessor-based or programmable consumer electronics, network PCS, minicomputers, mainframe computers, cellular telephones, smart phones, display pagers, radio frequency (RF) devices, infrared (IR) devices, Personal Digital Assistants (PDAs), laptop computers, wearable computers, tablet computers, a device of the IPOD or IPAD family of devices manufactured by Apple Computer, integrated devices combining one or more of the preceding devices, or any other computing device capable of performing the methods and systems described herein. The embodiments may also be practiced in distributed computing environments where tasks are performed by remote processing devices that are linked through a communications network. In a distributed computing environment, program modules may be located in both local and remote memory storage devices.

The exemplary hardware and operating environment of FIG. 13 includes a general purpose computing device in the form of a computer 720, including a processing unit 721, a system memory 722, and a system bus 723 that operatively couples various system components including the system memory to the processing unit 721. There may be only one or there may be more than one processing unit 721, such that the processor of computer 720 comprises a single central-processing unit (CPU), or a plurality of processing units, commonly referred to as a parallel processing environment. The computer 720 may be a conventional computer, a distributed computer, or any other type of computer; the embodiments are not so limited.

The system bus 723 may be any of several types of bus structures including a memory bus or memory controller, a peripheral bus, and a local bus using any of a variety of bus architectures. The system memory may also be referred to as simply the memory, and includes read only memory (ROM) 724 and random access memory (RAM) 725. A basic input/output system (BIOS) 726, containing the basic routines that help to transfer information between elements within the computer 720, such as during start-up, is stored in ROM 724. In one embodiment of the invention, the computer 720 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media. In alternative embodiments of the invention, the functionality provided by the hard disk drive 727, magnetic disk 729 and optical disk drive 730 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 727, magnetic disk drive 728, and optical disk drive 730 are connected to the system bus 723 by a hard disk drive interface 732, a magnetic disk drive interface 733, and an optical disk drive interface 734, respectively. The drives and their associated computer-readable media provide nonvolatile storage of computer-readable instructions, data structures, program modules and other data for the computer 720. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 729, optical disk 731, ROM 724, or RAM 725, including an operating system 735, one or more application programs 736, other program modules 737, and program data 738. A user may enter commands and information into the personal computer 720 through input devices such as a keyboard 740 and pointing device 742. Other input devices (not shown) may include a microphone, joystick, game pad, satellite dish, scanner, touch sensitive pad, or the like. These and other input devices are often connected to the processing unit 721 through a serial port interface 746 that is coupled to the system bus, but may be connected by other interfaces, such as a parallel port, game port, or a universal serial bus (USB). In addition, input to the system may be provided by a microphone to receive audio input.

A monitor 747 or other type of display device is also connected to the system bus 723 via an interface, such as a video adapter 748. In one embodiment of the invention, the monitor comprises a Liquid Crystal Display (LCD). In addition to the monitor, computers typically include other peripheral output devices (not shown), such as speakers and printers. The monitor may include a touch sensitive surface which allows the user to interface with the computer by pressing on or touching the surface.

The computer 720 may operate in a networked environment using logical connections to one or more remote computers, such as a remote computer 749. These logical connections are achieved by a communication device coupled to or a part of the computer 720; the embodiment is not limited to a particular type of communications device. The remote computer 749 may be another computer, a server, a router, a network PC, a client, a peer device or other common network node, and typically includes many or all of the elements described above relative to the computer 720, although only a memory storage device 750 has been illustrated in FIG. 6. The logical connections depicted in FIG. 6 include a local-area network (LAN) 751 and a wide-area network (WAN) 752. Such networking environments are commonplace in offices, enterprise-wide computer networks, intranets and the Internet.

When used in a LAN-networking environment, the computer 720 is connected to the local network 751 through a network interface or adapter 753, which is one type of communications device. When used in a WAN-networking environment, the computer 720 typically includes a modem 754, a type of communications device, or any other type of communications device for establishing communications over the wide area network 752, such as the Internet. The modem 754, which may be internal or external, is connected to the system bus 723 via the serial port interface 746. In a networked environment, program modules depicted relative to the personal computer 720, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for screen sharing on a portable computing device having a display device, the method comprising:
running a first application (app) comprising a primary media element on a display area;
receiving a user input touching/pressing/clicking over a predefined region of the display area;
in response to the user input, displaying a banner comprising a list of content elements pertaining to different apps (EOA), each EOA representing only a portion of available functions in a given app;
receiving a user input selecting a given EOA of a second app different than the first app;
in response to the user selection of the given EOA:
dividing the display area into two different regions including a first region and a second region;
running only the primary media element of the first app as a primary EOA in the first region; and
running the given EOA of the second app as a secondary EOA in the second region;
thereby running content elements of different apps simultaneously on the display device of portable computing device.

2. The method of claim 1, wherein the steps of receiving to running the selected EOA exclude any pausing and/or interruption of the primary media element of the first app.

3. The method of claim 1, further comprising extracting the EOAs from existing apps using an API (application program interface) feed.

4. The method of claim 1, further comprising receiving a user input touching/pressing/clicking over another predefined region of the display area, and, in response, displaying a search box for searching primary media of the first app in the second region without interrupting/pausing a media element content currently playing in the first region.

5. The method of claim 1, further comprising receiving a user input swiping the first region in a given direction, and, in response, displaying the primary media of a second app different than the first app.

6. The method of claim 5, further comprising receiving a user input swiping the first region in a given direction, and, in response, displaying a menu bar in the second region without interrupting/pausing a media content currently playing in the first region.

7. The method of claim 1, further comprising receiving a user input swiping the banner in a given direction, and in response, displaying further EOAs.

8. The method of claim 7, further comprising providing a location in the banner, said location when touched/pressed/clicked over causes an original order of EOAs to be restored in the banner.

9. The method of claim 1, wherein each EOA represents a single function of available functions in the given app.

10. The method of claim 1, wherein each EOA represents two or more functions of available functions in the given app.

11. The method of claim 1, further comprising providing an invisible grid over the second region, the invisible grid comprising a plurality of different spaces, each space being associated with a given EOA, wherein upon receiving a user input over a given space running the EOA associated with the given space in the second region.

12. The method of claim 1, further comprising providing a number of EOAs in groups and providing a virtual rolling wheel for displaying the EOAs associated with a given group in the banner.

13. The method of claim 12 further comprising: color coding the groups.

14. The method of claim 1, wherein the portable computing device comprises an orientation sensing device, the method further comprising running the primary media on the entire display when sensing a change of orientation of the portable computing device.

15. The method of claim 14, wherein the change of orientation comprises a change from a portrait mode to a landscape mode.

16. A computing device for implementing the method of claim 1.

17. A user interface implemented on a computing device having a display, the interface comprising:
A display area for running a first application comprising a primary media; wherein upon detecting a user input over a selected region of the display area the interface displays a banner comprising a list of content elements pertaining to different apps (EOA), each EOA representing only a portion of available functions in a given app; wherein upon receiving a user input selecting a given EOA of a different app the interface divides the display area into two regions:
a first region for running only the primary media of the first app as a primary EOA, and
a second region for running the given EOA of the different app.

18. The interface of claim 17, wherein the interface displays the banner and runs the secondary EOA without pausing/interrupting the primary media.

19. The interface of claim 17, wherein the interface is adapted to provide a number of EOAs in groups and provide a virtual rolling wheel for displaying the EOAs associated with a given group in the banner.

20. The interface of claim 17, wherein the interface is adapted to extract the EOAs from existing apps using API.
